(19) United States
(12) Patent Application Publication
(10) Pub. No.: US 2005/0199141 A1
(43) Pub. Date: Sep. 15, 2005

(54) Variable embossing method and apparatus for substrates

(76) Inventor: Philip Uglow, Toronto (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 10/798,436

(22) Filed: Mar. 12, 2004

(51) Int. Cl. B31F 1/07

(52) U.S. Cl. 101/22; 101/478

(57) ABSTRACT

A method of forming relief in a surface of a sheet utilizing a forming platen whose relief can readily be changed and an apparatus for forming relief in a surface of a sheet incorporating a platen whose relief can readily be controlled and varied on a real time basis, preferably, with piezoelectric actuators reciprocally driving small pixel elements into the surface of the sheet. The method involves using a first platen which carries an input relief. The first platen is to be urged into contact with a surface of a sheet such that the input relief on the first platen forms an output relief in the surface of the sheet corresponding to the input relief. The method involves contacting a first portion of the sheet with a first portion of the first platen to transfer the relief to the sheet, removing the first portion of the first platen from contact with the first portion of the sheet, changing the input relief on the first portion of the first platen to become different and, subsequently, using the first portion of the first platen to transfer its changed relief to a different portion of the sheet. By repeatedly changing the input relief on the first portion of the first platen and repeatedly applying this input relief to different portions of the sheet, the sheet may have applied over the entirety of its surface a desired output relief representing the input relief from the first platen as changed with time.

### SCOPE OF THE INVENTION

This invention relates to a method and apparatus for forming relief in a surface of a sheet by use of a relief carrying platen on which the relief may be changed.

### BACKGROUND OF THE INVENTION

It is known to emboss a sheet by passing the sheet between a pair of embossing rollers so as to impart the relief of the embossing rollers onto the sheet as by permanently deforming the sheet. The transfer of the relief from the embossing roller to the sheet is known to be carried out with thermoplastic sheets with the sheet at a temperature that the sheet is formed to assume the relief and, subsequently, the sheet is cooled. However, provided sufficient force is applied to a sheet, many sheets, including thermoplastic sheets, will be permanently deformed.

Embossing rollers which are known are provided to have a relief which is permanent. With such known permanent embossing rollers, to change the relief which is to be embossed onto a sheet, it is necessary to replace the embossing roller with a different embossing roller.

Known embossing rollers with permanent relief have the disadvantage that they are relatively expensive and require considerable time for their manufacture. Such permanent embossing rollers suffer the disadvantage that they cannot be inexpensively created or inexpensively modified for use in embossing different reliefs.

### SUMMARY OF THE INVENTION

To at least partially overcome these disadvantages of the previously known devices, the present invention provides a method of forming relief in a surface of a sheet, preferably, a plastic or thermoplastic sheet, utilizing a forming platen whose relief can readily be changed.

The invention also provides an apparatus for forming relief in a surface of a sheet incorporating a platen whose relief can readily be controlled and varied on a real time basis, preferably, by the use of a plurality of piezoelectric actuators.

The invention also provides a method of forming relief in a surface of a substrate with piezoelectric actuators carried on a platen.

An object of the present invention is to provide a method and apparatus for forming relief in a surface of a substrate, preferably, a plastic or thermoplastic substrate.

In one aspect, the method of this invention provides for forming relief in a surface of a substrate. The method involves using a first platen which carries an input relief. The first platen is to be urged into contact with a surface of a substrate such that the input relief on the first platen forms an output relief in the surface of the substrate corresponding to the input relief. The method involves contacting a first portion of the substrate with a first portion of the first platen to transfer the relief to the substrate, removing the first portion of the first platen from contact with the first portion of the substrate, changing the input relief on the first portion of the first platen to become different and, subsequently, using the first portion of the first platen to transfer its changed relief to a different portion of the substrate. By repeatedly changing the input relief on the first portion of the first platen and repeatedly applying this input relief to different portions of the substrate, the substrate may have applied over the entirety of its surface a desired output relief representing the input relief from the first platen as changed with time. A preferred substrate comprises a sheet of material, preferably a thermoplastic material.

In the context of a platen in which the input relief is carried on a roller or a continuous belt, by rotation of the roller or movement of the belt, the input relief on the first portion may be cyclically moved between an engaged sector in which the input relief is in engagement with the substrate and a disengaged sector in which the input relief is not engaged with the substrate. In accordance with the present invention, the input relief is preferably changed when the input relief is in the disengaged sector. In the context of a platen comprising a plate, the plate, as a unit or each pixel element individually, may be reciprocally moved from a position in engagement with the substrate to a position not in engagement with the substrate and the input relief may be preferably changed when the platen or pixel element is not engaged with the substrate. A plate platen could be flat or concave or convex.

In the context of fixed platens having a row of pixel elements, with movement of the sheet transverse to the fixed platens, the individual pixel elements may be repeatedly extended and withdrawn, preferably, quickly compared to the speed of advance of the sheet, to selectively apply forces to the sheet at desired locations to provide a resultant output relief.

The input relief of the first platen may be provided by many different arrangements. One preferred arrangement is to have a plurality of pixel elements arranged adjacent each other in a two dimensional array to cover or substantially cover an area of the platen. Another preferred arrangement is to have a plurality of pixel elements arranged adjacent another in a row which preferably extends across the entire width of a sheet to be formed. Another arrangement is to have either a platen head with one pixel element or a row of pixel elements or an array of pixel elements which cover a dimension or area less than the width or length of a sheet and selectively move the platen head to different locations transverse and/or longitudinally relative the sheet to form the sheet at selected locations to which the platen is moved.

Each pixel element defines a segment of the input relief of the first platen and with each pixel element movable relative the first platen between an unraised or retracted position and a raised position. The pixel elements may, for example, comprise movable pins which can be moved to extend to different relative depths such that the heads of the pins provide a relief with different elevations over the array.

Each pixel element may define a segment of the input relief on the platen. For example, a head of a pin-like pixel element may comprise such a segment which may be set at a desired relative unraised or raised position. The pixel elements in an array may have heads, such as, preferably, hexagons, with edges which are continuous with edges of heads of adjacent pixel elements such that when the heads are in the same plane, they provide a continuous plane. Alternatively, the pixel elements may have heads whose edges are spaced from edges of heads of adjacent pixel elements as, for example, in the manner of cylindrical pins whose circular end surface may form a series of circular segments or dots in the array. The extent to which the dots are spaced from each other will be a factor in determining the nature and sharpness of a resultant output relief.

The forming surface of the first platen may be alternatively provided with the input relief by the use of a surface layer of an electroactive material whose thickness increases or decreases as controlled by selectively passing positive or negative charges to discrete areas of its surface. Each discrete area to which a positive or negative charge would be applied, would comprise a pixel element movable relative the platen between a retracted position and a raised or extended position.

The method and apparatus of the present invention provides a forming surface which defines the input relief in a changeable, non-permanent configuration. The forming surface can form and temporarily retain an input relief and, subsequently, rapidly be formed and changed to adopt a subsequent different input relief.

In accordance with a preferred aspect of the present invention, the input relief is preferably urged into a surface of the thermoplastic substrate with the thermoplastic substrate at a temperature at which the substrate will be permanently deformed to form an output relief on the surface of the substrate and, preferably, the surface of the substrate is then cooled to a temperature at which the substrate will substantially permanently retain the output relief. This may be carried out by various known methods including providing the plastic substrate immediately prior to engagement with the input relief on the first platen to be at a desired elevated temperature and subsequently cooling the substrate. The first platen may be cooled to assist in cooling the substrate so as to permanently set the output relief in the substrate. The substrate may be provided as a sheet which may be heated by various means such as heated rollers, air blowers and the like prior to engagement by the input relief. The substrate may have substantial depth and may merely have thermoplastic material proximate the surface to carry the output relief heated to a desired temperature. The substrate may comprise a flexible plastic sheet, membrane or laminate.

As substrates, flexible plastic films, flexible plastic membranes and laminates of the same may be formed, laminated and/or co-extruded upstream from the relief-forming apparatus in accordance with the present invention with the product cooling sufficiently for engagement by the input relief of the first platen and, subsequently, being further cooled to maintain the output relief.

The invention is not limited to use of thermoplastic materials as the substrate or when thermoplastic materials are to be used requiring the thermoplastic material to be heated and/or cooled. The present inventor has appreciated that most materials, when subjected to sufficiently high forming pressures, become permanently deformed. Thus, most plastic materials and thermoplastic materials when formed under pressures of at least 500 pounds per square inch, more preferably, 600 pounds per square inch and, more preferably, at least 700 pounds per square inch, are permanently deformed at typical ambient temperatures. Similarly, other materials such as metal, Bristol board, paper and leather, will permanently deform under adequate pressures.

Each of the plurality of pixel elements which are carried in an array on the first platen preferably have an activation mechanism to move each pixel element between the retracted position and the raised extended position and, preferably, are to be effectively maintained or locked against movement in selected positions at the retracted position or the extended position or any position in between. If necessary, a releasable locking mechanism may be provided to lock each pixel element against movement in a desired position.

Preferred activation mechanisms for the pixel elements utilize the high force generating capability of electrically induced strain materials, such as piezoelectric materials and terfenol-D materials which offer high force output with small displacement.

Piezoelectric actuators may be direct piezo actuators, however, direct piezo actuators typically provide for only small displacements. More preferred are amplified piezo actuators which are based on the expansion of a piezoelectric material and on a mechanism for amplifying the displacement, preferably, to provide a relatively long stroke linear actuator. The mechanism for amplifying may have many forms including mechanical or hydraulic. Hydraulic amplifying mechanisms and piezoelectric actuators incorporating them are disclosed, for example, in U.S. Pat. No. 6,093,995 to Lazarus, the disclosure of which is incorporated herein.

Terfenol-D materials are described in U.S. Pat. No. 6,515,382 to Ullakko, issued Feb. 4, 2004.

Piezoelectric actuators have the advantage of fast response time, for example, preferably less than 1 millisecond, preferably, less than 0.1 millisecond, and generation of large forces, for example, preferably greater than 1000 N (787 lb/ft). Piezoelectric actuators are modular and readily controlled.

Other activation mechanisms may comprise solenoid type activators which may be electrically activated to move to a desired position and preferably locked in place.

Preferably, the activation mechanism to move each pixel element and, if necessary, any releasable locking mechanism to lock each element in a desired position may be controlled using a computer interface and a software driver which controls the position of each pixel member and the timing of any changes in the position of the pixel member. The relief, such as a pattern, design or the like which is desired, can be developed using standard three dimensional solid modelling CAD software and suitable software driver and applied to the pixel elements and any locating carriages for the pixel elements to provide a desired input relief. The input relief on the first platen may be changed with time by the computer interface and software and changed as desired so as to adopt an infinite variety of different reliefs. Not only can three dimensional CAD software be used to create any desired relief but three dimensional imaging in computer systems and software can be used to copy existing relief as, for example, natural occurring substances such as grain leather or, for example, to reproduce a man-made relief pattern in another substrate.

A relief-forming or embossing method and apparatus in accordance with the present invention permits relief to be immediately changed and is advantageous in respect of costs and timing of producing substrates, preferably thermoplastic substrates with desired relief. The method and apparatus in accordance with the invention are adaptable to manufacture relief carrying products which are unique or customized or otherwise are provided in small quantities.

By changing the input relief continuously, rather than merely providing a repeating output image in the case of a permanent embossing roller, the output image can be changed continuously so as to avoid having periodically repeating patterns.

The apparatus and method of the present invention are particularly adapted for the manufacture of custom embossed plastic coated fabrics which can be used for various applications such as, for example, in advertising as graphic media; in agriculture as agricultural embossed and permeated films; as coverings for household electrical appliances and housewares; as covering for vehicle components such as automotive dashboards, automotive insulation, automotive seating, school bus seating, and interior side and roof panels for vehicles; as airplane and aviation air barriers; as paper binding and other office products including covers for paper binders, folders and paper jackets; and in building and construction as barriers, decking, flooring, plastic coatings for metals, plastic coatings for plywood, tension fabrics, roof panels, roofing sheetings, roof membranes, wall coverings, water and vapour barriers; and in electronics and electrical fields as insulation, and as general fabrics as for use in bags, luggage, clothing, furniture, footwear and the like.

Accordingly, in one aspect, the present invention provides a method of forming relief in a surface of a substrate comprising selectively reciprocally moving with a piezoelectric actuator, a relief forming head of a pixel element into and away from the surface of the sheet at different locations over an area of the sheet.

In another aspect, the present invention provides an apparatus for forming relief in a surface of a sheet, the apparatus comprising:

a first platen,

a second platen disposed in opposition to the first platen,

the first and second platens adapted to receive a portion of an elongate sheet of material therebetween,

an advance mechanism to advance the sheet relative the platens,

the first platen carrying at least one pixel element reciprocally movable relative the first platen towards the second platen to desired positions between a retracted position and an extended position,

an activation mechanism to move the pixel element between the retracted position and the extended position comprising an electrically induced strain material which generates displacement forces, and

a control mechanism to control the activation mechanism and advance mechanism whereby reciprocal movement of the at least one pixel element forms a relief on the surface of the sheet.

In another aspect, the present invention provides a method of forming relief in a surface of a thermoplastic sheet comprising the steps of:

step (1): sandwiching a first portion of an elongate sheet of thermoplastic material between a first portion of first platen and a second platen disposed in opposition to the first platen such that contact of a surface of the first portion of the sheet with the first portion of the first platen forms a first output relief in said surface of the first portion of the sheet corresponding to a relief on the first portion of the first platen, and

step (2): removing the first portion of the first platen from contact with the sheet,

step (3): changing the relief on the first portion of the first platen to become different than the relief in an immediately preceding sandwiching step,

step (4): sandwiching between the first portion of first platen and the second platen disposed in opposition to the first platen a different portion of the elongate sheet of thermoplastic material that has not been sandwiched in a previous sandwiching step such that contact of a surface of the different portion of the sheet with the first portion of the first platen forms an output relief in said surface of the different portion of the sheet corresponding to the relief on the first portion of the first platen.

Another aspect of the present invention provides an apparatus for forming relief in a surface of a thermoplastic sheet, the apparatus comprising:

a first platen,

a second platen disposed in opposition to the first platen,

an input relief carried on the first platen,

the first and second platens adapted to receive a portion of an elongate sheet of thermoplastic material therebetween sandwiching the sheet between the platens such that contact of a surface of the sheet with the first platen forms an output relief in said surface of the sheet corresponding to the input relief,

an advance mechanism to advance the sheet relative the platens for successive forming of the output relief on the surface at different portions of the sheet,

the first platen comprising a plurality of pixel elements arranged adjacent each other in an array with each pixel element defining a segment of the input relief of the first platen,

each pixel element movable relative the first platen between a retracted position and an extended position,

an activation mechanism to move each pixel element between the retracted position and the extended position, and

a control mechanism to control the activation mechanism and advance mechanism whereby the input relief can be varied by the movement of the pixel elements to change the input relief with time and thus form different output reliefs on different portions of the surface of the sheet.

### BRIEF DESCRIPTION OF THE DRAWINGS

Further aspects and advantages of the present invention will become apparent from the following description taken together with the accompanying drawings in which:

FIG. 1 is a schematic pictorial view of an embossing apparatus in accordance with the first embodiment of this invention;

FIG. 2 is a schematic partial cross-sectional side view of the embossing platen of FIG. 1 along section line 2-2′;

FIG. 3 is an enlarged schematic cross-sectional view along section line 3-3′ of FIG. 2;

FIG. 4 is a schematic view of a frame assembly comprising part of the apparatus of FIG. 1;

FIG. 5 is a schematic view of an alternate frame assembly for use with an alternate embodiment of the apparatus as illustrated in FIG. 1;

FIG. 6 is a view of a small segment of the area of the outer surface of the first platen shown in FIG. 1;

FIG. 7 is a view similar to FIG. 6 but with a different array of circular pixel elements in accordance with the present invention;

FIG. 8 is a view similar to FIG. 6 but with an array of hexagonal pixel elements in accordance with the present invention;

FIG. 9 is a pictorial view of a head of a hexagonal pixel element shown in FIG. 8;

FIG. 10 is a schematic pictorial view of a forming apparatus in accordance with a second embodiment of the invention;

FIG. 11 is an enlarged pictorial view of the platens as seen in FIG. 10;

FIG. 12 is a side view showing the ends of the platens as seen in FIG. 11;

FIG. 13 is a bottom view of the upper platen of FIG. 12;

FIG. 14 is an enlarged pictorial view similar to FIG. 11 but with an upper platen in accordance with a third embodiment of the invention;

FIG. 15 is a side view showing the ends of the platens as seen in FIG. 14 but additionally showing a mechanism to move a carriage;

FIG. 16 is a bottom view of the upper platen of FIG. 15;

FIG. 17 is an end view of a forming apparatus utilizing a concave platen in accordance with a fourth embodiment of the present invention;

FIG. 18 is a partial cross-sectional side view through the platen of FIG. 17;

FIG. 19 is a schematic partially cross-sectioned pictorial view of a platen in accordance with a fifth embodiment of the present invention.

### DETAILED DESCRIPTION OF THE DRAWINGS

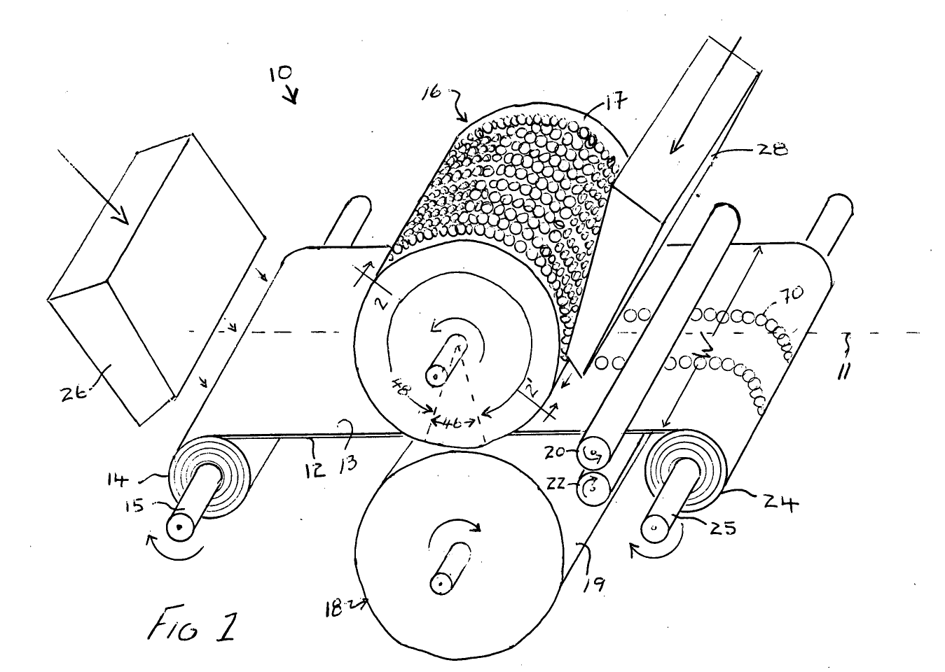

Reference is made first to FIG. 1 which schematically illustrates an apparatus 10 in accordance with the first embodiment of the present invention. The apparatus 10 shows a sheet 12 of thermoplastic material which is wound as an input roll 14 journalled about an input shaft 15. The sheet 12 passes between a first platen 16 and a second platen 18 and between two drive rollers 20 and 22 to become wound as an output roll 24 about an output shaft 25. Each of the input shaft 15, platens 16 and 18, driver rollers 20 and 22 and output shaft 25 are rotated in a direction indicated by the various arrows in FIG. 1 so as to cooperate in unrolling the sheet 12 from the input roll 14 and winding the sheet 12 onto the output roll 24.

Each of the input shaft 15, first platen 16, second platen 18, driver roller 20, driver roller 22 and output shaft 22 as suitably mounted in relative relation for rotation about parallel axis, however, with the first platen 16 and second platen 18 being adapted to selectively sandwich and compress the sheet 12 in the nib therebetween. Similarly, the driver rollers 20 and 22 are adapted to be urged towards each other to engage the sheet 12 therebetween as can be advantageous for the driver rollers 20 and 22 to assist in advancing the sheet 12 at a controlled speed, preferably, the tangential speed, of the platens 16 and 18.

In preferred operation of the apparatus 10, the sheet 12 is advanced relative to the platens 16 and 18 preferably with the surfaces 39 and 19 of the platens 16 and 18 to move at the same speed as the sheet 12.

A hot air duct 26 is schematically illustrated to direct heated air on the sheet 12 to heat the sheet 12 before it reaches the platens 16 and 18. A cool air duct 28 is schematically shown to direct cool air onto the upper platen 16 and the sheet 12 on the exit side of the platens to cool the sheet 12.

The lower, second platen 18 is shown as being a cylindrical roller having a smooth, cylindrical external surface 19. The upper, first platen 16 is illustrated as including a cylindrical roller 17.

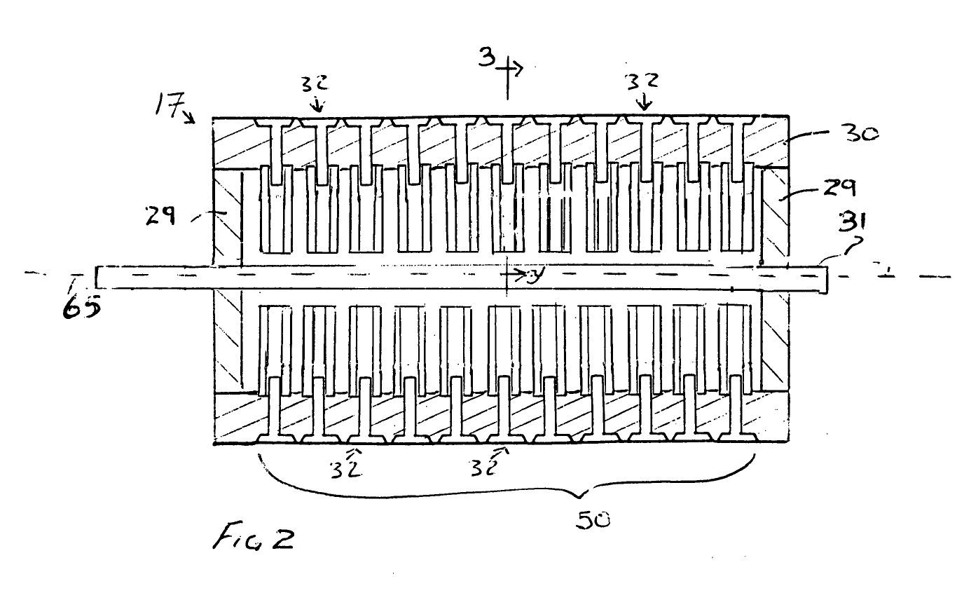

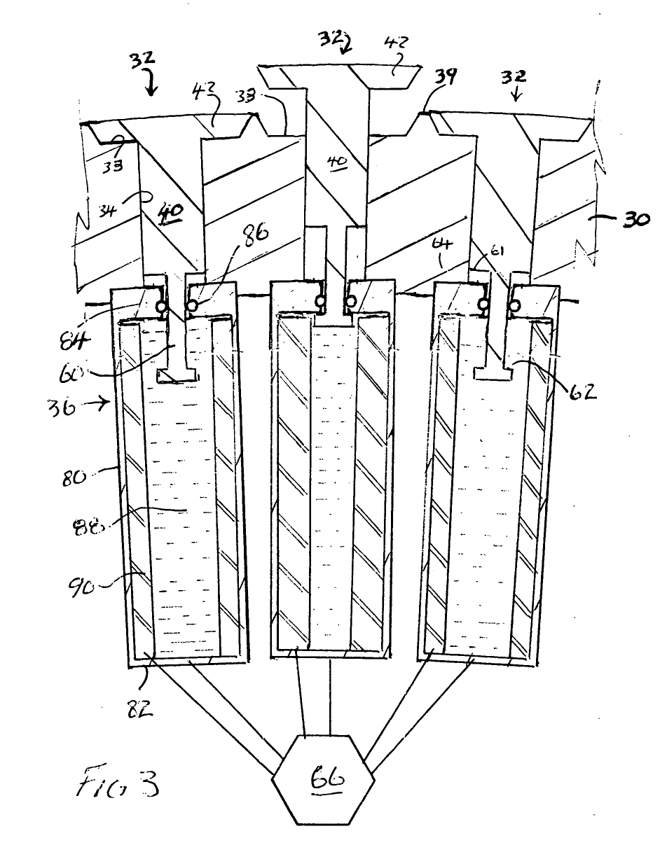

The roller 17 illustrated in the cross-sectional side view of FIG. 2 as having a cylindrical wall 30 closed at its ends by end wall plates 29 and rotatable about journal axle 31. The wall 30 carries a plurality of pixel elements 32 in an array shown as a plurality of transverse rows 50 extending axially across the wall 30 parallel a platen axis 65 about which the first platen rotates. FIG. 2 shows a cross-section showing two diametrically opposed transverse rows 50, each of eleven pixel elements 32. FIG. 3 is an enlarged cross-section along section line 3-3′ in FIG. 2, showing three circumferentially spaced pixel elements 32 lying in the same circumferential row. For each pixel element 32, the wall 30 is provided with a bore-like chamber 34 having radially outward open end 33 and a radially inner open end. An activation cylinder 36 has its radially outer end secured to the wall 30 in an annular recess of the wall about the inner open end of the chamber 34. The cylinder 36 has a cylindrical side wall 80, a radially inner end wall 82 and a radially outer end wall 84. The outer end wall 84 has central passageway therethrough through which a reduced diameter cylindrical portion 60 of the stem 40 of the pixel element extends. An O-ring 86 is disposed within the central passageway to form a fluid seal between the stem 40 and the outer end wall 84 and to seal non-compressible fluid 88 which fills the cylinder 36. An annular piezoelectric element 90 is disposed within the cylinder 36 coaxially therein. The piezoelectric element 90 has a volume which increases when a voltage is applied across it. Expansion of the piezoelectric element 90 displaces the fluid 88 in the cylinder 36 displacing the stem 40 which acts as a piston in the cylinder 36. FIG. 3 shows a condition in the middle cylinder 36 with the piezoelectric element 90 having been expanded radially, relative cylinder 36, inwardly so as to have its pixel element 32 extended radially, relative the wall 30, outwardly as contrasted with the unexpanded radial width of each side of the annular piezoelectric elements 90 in the two other cylinders 36 from which the pixel elements 32 are not extended.

The piezoelectric element 90 may be of a known type, for example, as a composite actuator or bimorph which can be made by sandwiching a metal between two thin piezoceramics which are oppositely poled. When a voltage is applied to the bimorph, one piezoceramic expands while the other contracts, introducing a bending motion of displacement or expansion into the composite element. The displacement of the piezoelectric element 90 is amplified by hydraulic transmission, that is, by displacement in the master cylinder 36 that acts on a smaller diameter actuator piston of the pixel element 32 in the same cylinder 36. Such hybrid electrohydraulic actuators are known as, for example, disclosed in U.S. Pat. No. 6,093,995 to Lazarus, issued Jul. 25, 2000 and U.S. Pat. No. 6,034,466 to Blanding, issued Mar. 7, 2000.

Such patents teach hybrid devices wherein electrically actuated elements that change dimension in response to an applied electrical drive signal are used to displace fluid for driving a hydraulic ram. The hybrid devices can be designed to select suitable stroke displacement and force output. The devices are modular.

Each pixel element 32 has an elongate stem 40 and a head 42. The stem 40 is slidably received in its respective chamber 34 for sliding between a retracted position as illustrated in the two outer pixel elements 32 illustrated in FIG. 3 and a raised extended position as illustrated in the one middle pixel element 32 illustrated in FIG. 3. As seen, in the extended position, the head 42 of the pixel element 32 extends from the outer open end 33 of the chamber 34. In the extended position, the head 42 of the pixel is raised radially outwardly beyond the outer cylindrical surface 39 of the wall 30 of the first platen 16. FIG. 3 shows the stem 40 having the reduced diameter portion 60 ending at a radially outward end as a forward stop shoulder 61 and at a radially inward end as a rear stop shoulder 62. The outer end wall 84 of the cylinder 36 extends radially into the reduced diameter portion 60 and by axial engagement with the forward stop shoulder 61 and rear stop shoulder 62 limits axial sliding of the pixel member 32 between the extended and retracted positions.

Each piezoelectric element 90 is illustrated as being functionally connected to a control mechanism 66 to, amongst other things, selectively control the electrical signal applied to each element 90 and thereby control the location of the pixel element 32 between the retracted and the extended positions.

The first platen 16 is illustrated as carrying a plurality of pixel elements 32 arranged adjacent each other in an array. In this regard, the pixel elements 32 are shown in FIGS. 1 and 2 to be provided in transverse rows 50 which extend longitudinally across the length of the first platen 16 parallel platen axis 65 about which the first platen 16 rotates and fully across a width W of the sheet 12. The pixel elements 32 are also shown in FIGS. 1 and 3 to be provided in circumferentially extending rows which extend circumferentially about the circumference of the first platen 16 centered in a plane normal the platen axis 65.

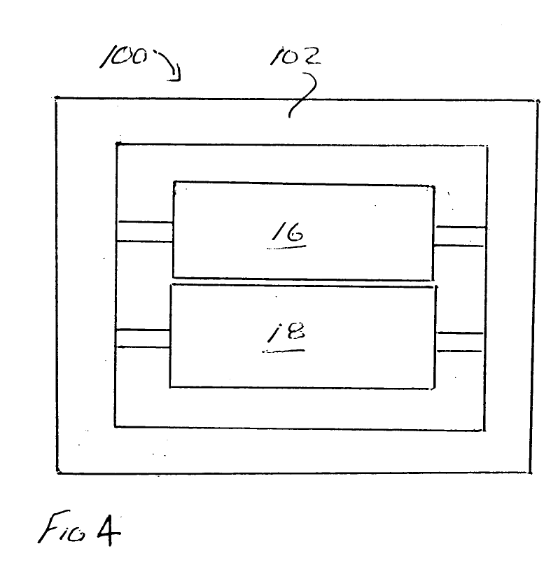

Reference is made to FIG. 4 which shows a frame assembly 100 comprising a fixed frame 102 to which both the first platen 16 and second platen 18 are fixedly mounted journalled for rotation about their respective axis. The first platen 16 and second platen 18 are secured to the frame 102 against relative movement towards or away from each other. For ease of illustration, the pixel elements 32 have not been shown, nor has the sheet 12. The first platen 16 and second platen 18 are spaced a distance which does not necessarily apply any significant pressure onto the sheet 12 when the pixel elements are in the retracted position. The first platen 16 and the second platen 18 may be spaced a distance greater than the thickness of the sheet 12, or equal to the thickness of the sheet 12 or less than the thickness of the sheet 12. When any pixel element 32 is extended from its retracted position, the pixel element 32 must be capable of maintaining its retracted position against the forces that will be generated on that pixel element 32 rotating through the nib and being compressed into the sheet 12 between the first platen 16 and second platen 18.

In accordance with the preferred embodiment where piezoelectric hydraulic actuators are used as illustrated in FIGS. 2 and 3, the pressure with which and depth to which each pixel element 32 engages the sheet 12 can effectively be controlled for a sheet 12 of uniform thickness and characteristics by selection and control of the piezoelectric actuators for the pixel elements 32 and without the need for another mechanism to urge the first and second platens together. With the frame assembly 100, the first platen 16 and second platen 18 are to be fixed to the frame 100 against movement during operation, however, an adjusting mechanism should be provided to accurately space the platens prior to operation.

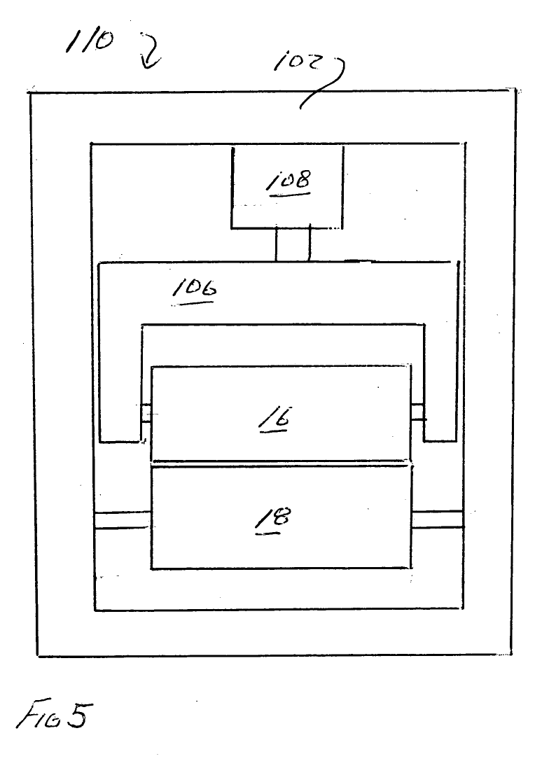

Reference is made to FIG. 5 which shows an alternate hydraulic press frame assembly 110 for substitution for the hydraulic press frame assembly of FIG. 4.

The hydraulic press frame assembly 110 has frame 102 to which second platen 18 is fixedly mounted journalled. The first platen 16 is fixedly mounted to a yoke 106 vertically slidably mounted to the frame 102. A hydraulic cylinder 108 moves the yoke 106 and is adapted to urge the first platen 16 into the second platen 18 under forces as may be desired. The hydraulic press frame assembly 110 is suitable for use where the platens 16 and 18 are to be spaced a distance that pressure is to be applied by any pixel elements 32 which are not extended, and to control such pressure as, for example, to accommodate variation such as in the sheet thickness or composition or temperature.

The pixel elements 32 of the first platen 16 together with the surface 39 of the first platen 16 provides an input relief. The input relief is a description of the relative elevation of the outermost surfaces of the platen 16. The input relief will vary depending upon the relative positions of the pixel elements 32. As the sheet 12 is moved through the nip between the first platen 16 and second platen 18, the sheet 12 is sandwiched between the platens such that contact of an upper surface 13 of the sheet with the first platen 16 forms an output relief in the surface 13 of the sheet 12 corresponding to the input relief on the first platen 16.

The pixel elements 32 in any transverse row 50 on the first platen 16 are in engagement with the sheet 12 when the first platen 16 is rotated so that transverse row 50 is at the nip between the two platens 16 and 18. To some extent, there may be engagement for any transverse row marginally on either side of the nip. An angular sector in which the pixel elements 32 on the first platen 16 in transverse rows 50 in that sector may be considered to be in contact or close to contact with the sheet is indicated as engaged sector 46 as seen in FIG. 1. A complementary disengagement sector 48 is a sector in which any pixel element 32 in that sector is not engaged with the sheet 12.

FIG. 3 schematically illustrates a control mechanism 66 which preferably comprises computer hardware and software to selectively move each pixel element 32 between its retracted and extended positions. Having regard to any particular transverse row 50 of pixel elements 32, the apparatus 10 is operated such that as each row 50 is rotated into the engaged sector 46, each row 50 has its pixel elements 32 individually located into desired positions so as to present a first input relief for that row. With the pixel elements 32 of the row 50 located and effectively locked in the desired position and presenting this first relief for the row, the row is rotated through the engaged sector 46 and brought into contact with the upper surface 13 of the sheet 12 such that a first portion of the sheet 12 becomes formed to adopt the input relief as an output relief in its upper surface 13. Subsequently, the row 50 of pixels 32 is rotated from the engaged sector 46 to the disengaged sector 48. While the row 50 is in the disengaged sector 48, the control mechanism 66 selectively, as desired, changes the positions of the pixel elements 32 in the row so as to change the input relief for the row 50. Thus, when such row 50 next comes to be rotated into the engaged section 46 to engage the sheet, the row 50 will contact the surface 15 of the sheet 12 over a different portion of the sheet 12 and thus form a new output relief in said different portion of the sheet corresponding to the new changed input relief of the first row 50.

Since the pixel elements 32 of each row may be changed when each row is in the disengaged sector 48, the input relief can be continuously changed as the first platen 16 rotates. Therefore, the apparatus 10 and its method of operation provide for forming relief in the upper surface 13 of the thermoplastic sheet 12 with the input relief to be pressed into the upper surface 13 of the sheet 12 to be continuously controlled and varied to any desired relief.

As best seen in FIG. 1, each transverse row 50 of the pixel elements 32 preferably extends parallel the axis of the first platen 16 entirely across the width W of the sheet 12. With each row 50 extending parallel the axis across the first platen 16, each row 50 will form an output relief on the upper surface 13 of the sheet 12 simultaneously across the width of the sheet. The sheet 12 may be seen to have a longitudinal generally indicated 11 in FIG. 1 and, in the preferred embodiment, the sheet 12 is advanced between the platens 16 and 18 parallel the longitudinal of the sheet 12, that is, with the platen axis 65 perpendicular to the longitudinal 11 of the sheet 12. The output relief is sequentially formed by each successive row on the platen 16 engaging the upper surface 13 of the sheet 12 at successive adjacent different portions of the sheet 12 longitudinally along the sheet.

The heads 42 of the pixel elements 32 preferably are provided over the surface 17 of the first platen 16 so as to cover as large a percentage as possible of the outer surface of the roller 17.

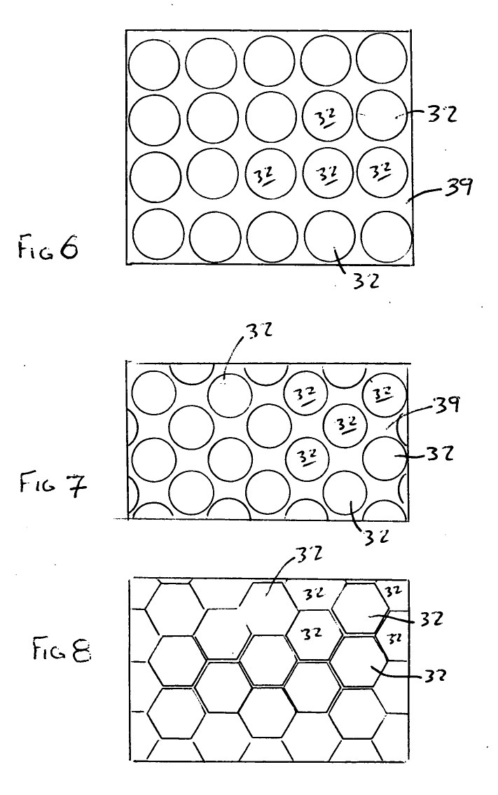

FIG. 6 illustrates a small area of the surface of the first platen 16 in FIG. 1 showing an arrangement with the pixel elements 32 of arranged in transverse rows 50 which extend across the platen 16 parallel the axis and, as well, in circumferential rows which extend circumferentially perpendicular to the transverse rows.

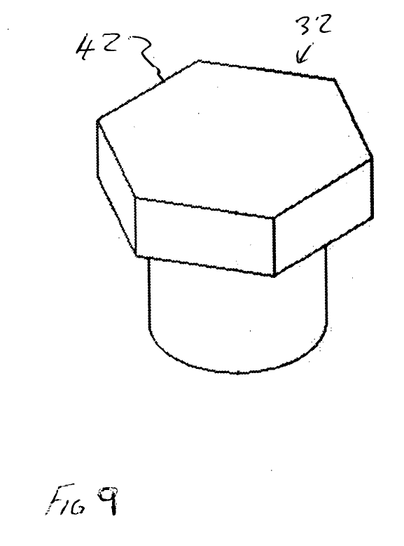

FIG. 7 is similar to FIG. 6 but illustrates a small area of the surface of a different platen illustrating another configuration in which the pixel elements 32 in each transverse row are staggered from adjacent pixels in an adjacent transverse row. While it may be advantageous to place the pixel elements in rows which extend transversely or circumferentially as shown in FIGS. 6 and 7, this is not necessary and the pixel elements can be in any array configuration towards covering the forming area of the platen, including those with diagonal rows, helical rows and random arrangement.

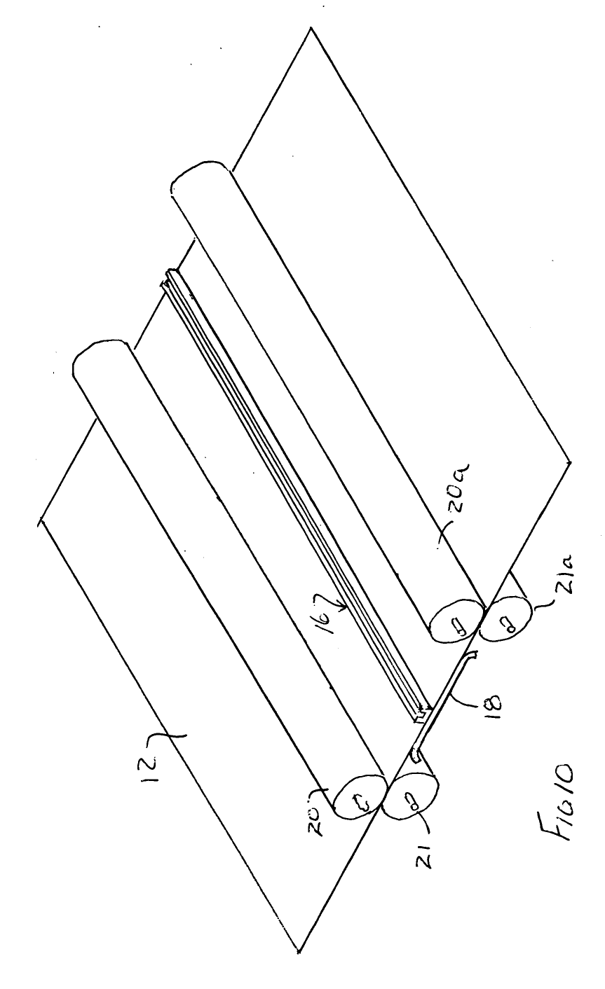

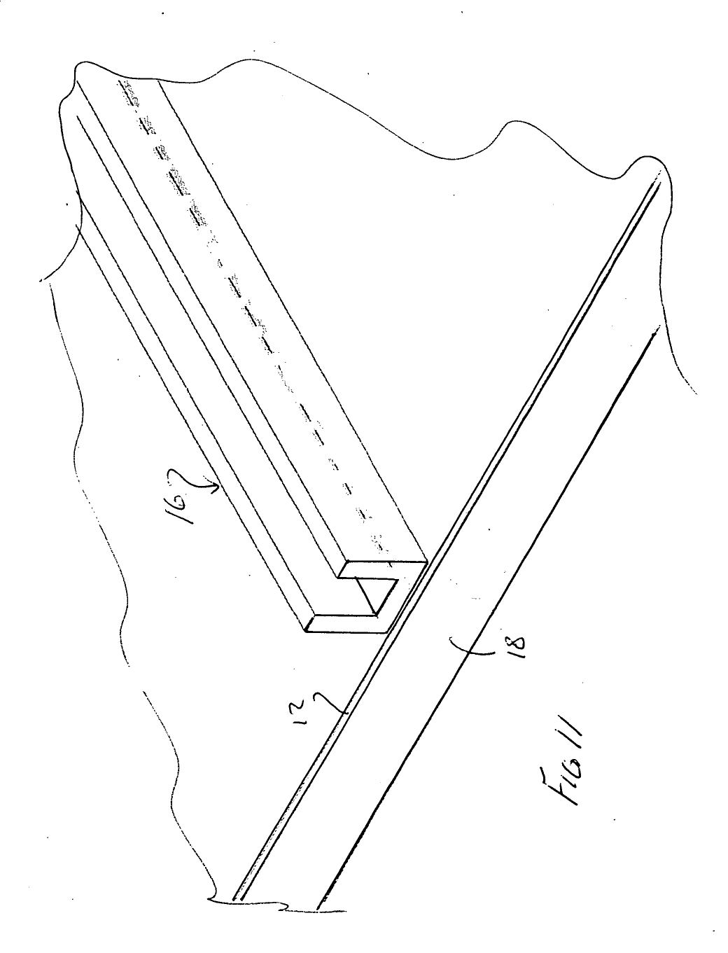

The pixel elements 32 illustrated in FIGS. 1, 6 and 7, show the head 42 as being circular and with lands of the outer cylindrical surface 39 forming part of the input relief between the heads 42. This is not necessary and the head may have any configuration desired including polygon such as squares, rectangles, hexagons, triangles and the like. A preferred hexagon shape for heads of pixel elements 32 is schematically illustrated in FIG. 8 which, like FIG. 6, shows a small area of the surface of a platen. FIG. 9 shows a preferred configuration for a hexagonal head 42 for the pixel element shown in FIG. 8. One preferred head 42 has a width between parallel sides of about 2.00 mm and each side of the hexagon of a length of 1.2 mm. Such a head 42 may preferably be driven by a piezoelectric element of a diameter of about 2.00 mm and a length of about 1.9 mm so as to provide a stroke of up to 0.50 mm over which the head may be extended. A preferred embodiment of a platen 16 as shown in FIGS. 1 to 3 would appear as in FIG. 6 with the pixel elements 32 having heads 42 as in FIGS. 7 and 9 and having, for example, about 100 pixel elements in each circumferential row for a circumference of about 200 mm and a diameter of about 64 mm. Axially, the platen may be as long as desired, preferably of lengths of 1 to 2 metres requiring about 1,000 to 2,000 such pixel elements in each axially extending rows.

Preferred roller platens whose surfaces are to substantially entirely be covered with pixel elements 32 are to have as small a circumference as possible to minimize the number of pixel elements 32 and, therefore, cost.

With pixel elements 32 with heads in the range of 1 mm to 5 mm and actuator cylinder lengths in the range of 1 mm to 10 mm, roller platen diameters may preferably be in the range of 20 mm to 1,000 mm, more preferably, in the range of 40 mm to 200 mm, however, size reduction is practically limited by challenges with assembly and construction.

Polygon structures may permit substantially the entirety of the input relief to be provided by the outwardly directed surfaces of the pixel elements. The relative size of each head of the pixel elements and their relative density will effectively determine the detail to which different patterns or shapes can be represented in the input relief.

Rather than provide the heads 42 to be enlarged in area compared to a cross-sectional area of the stem, the head 42 could be of the same cross-sectional area as the stem 40 as, for example, to merely comprise a pin member which can be extended through a bore-like chamber provided in the wall 30 of the first platen 16. Various arrangements can be provided to increase the density of such pins as, for example, by having the actuators, such as the actuation housing 36 in FIG. 3, for various pins staggered radially inwardly from the wall so as to avoid interference of the actuators and permitting a closer spacing of the individual pins.

For ease of illustration, the output image to be formed on the sheet 12 by the first platen 16 is shown in FIG. 1 as two parallel longitudinally extending rows of raised circular bosses 70.

The roller platen of FIGS. 1 to 3, 6, 7 and 8 have pixel elements 32 over substantially the entirety of the surface of the roller platen 16. This is preferred but not necessary. For example, a roller platen which is rotated about its axis could have but a single axially extending row of pixel elements 32 with the roller platen rotated at increased speed relative the sheet such that with each successive rotation, the pixel element 32 forms the sheet at a location on the sheet longitudinally spaced but adjacent to its location of previous forming. A plurality of spaced, individual transverse rows of pixels could be provided on the roller platen. Rather than have a single row, two or more rows of pixel elements 32 could be provided adjacent each other. The rows, whether single or multiple adjacent rows, could extend parallel the axis of the roller platen or could be helical about the axis of the roller platen. Reducing the number of pixel elements 32 can reduce the cost of the apparatus.

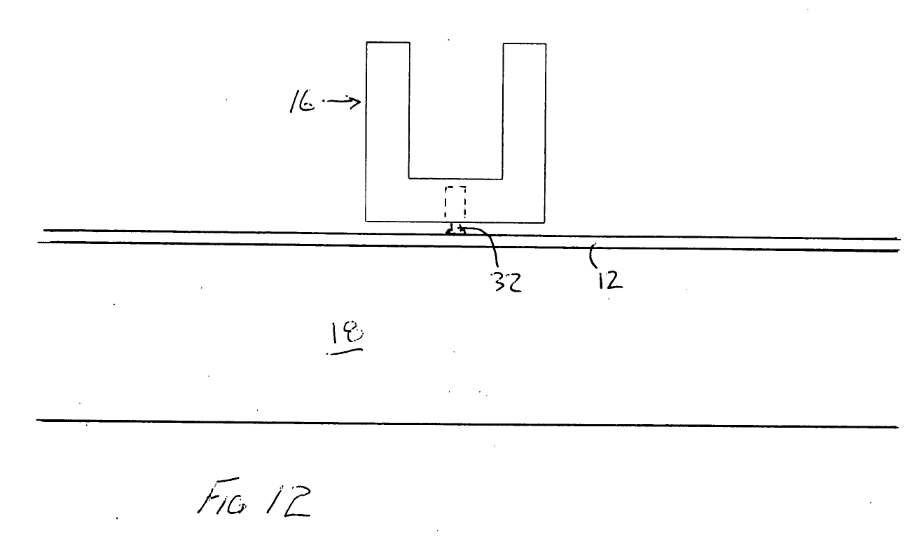

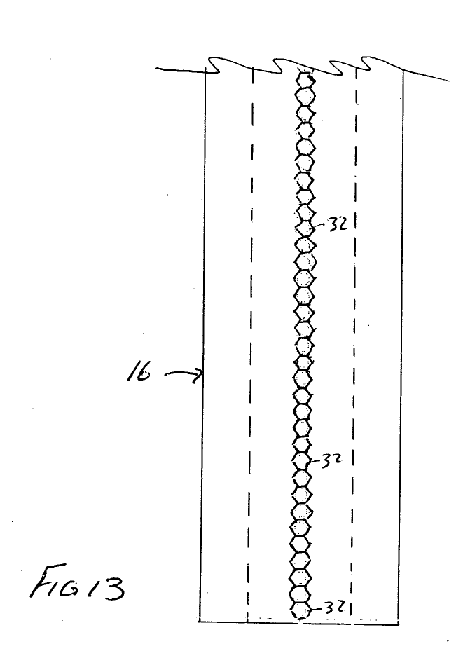

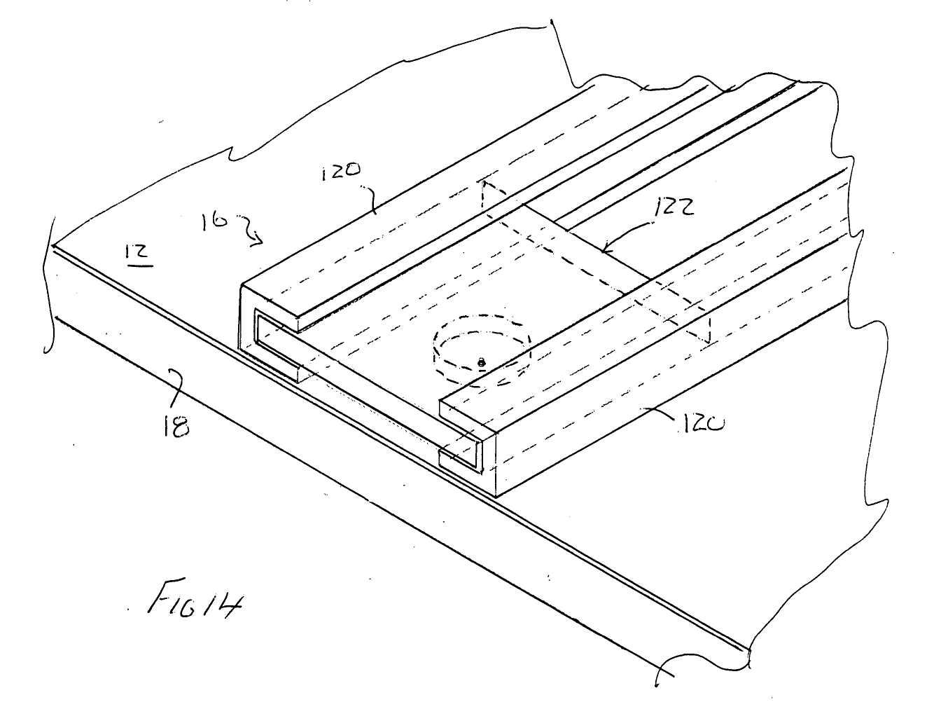

Reference is made to FIGS. 10 to 13 which illustrate a second embodiment of a forming apparatus in accordance with the present invention.

As seen in the pictorial view of FIG. 10, a sheet 12 is advanced by two pairs of drive rollers 20, 21 and 20a, 21a across a fixed lower platen 18 having a planar upper surface. A first platen 16 comprises a U-shaped support beam carrying a single row of pixel elements 32 with heads similar to that in FIG. 9 and each driven by an actuator, preferably, a piezoelectric element generally as indicated in FIGS. 2 and 3. The sheet 12 is advanced between the first and second platens 16 and 18 which are preferably fixed against movement away from each other. Movement of each pixel element 32 with time as desired will produce desired embossed patterns in the sheet 12. Piezoelectric actuators can extend and retract the heads of the pixel elements extremely quickly. Therefore, the speed of advance of the sheet 12 can readily be controlled to be slow relative the speed of extension and retraction of the heads of the pixel elements 32 as is advantageous for forming precise patterns by repeated movement of the heads of the pixel elements.

Each stroke of the pixel element 32 can be very quick, i.e. in fractions of a second, for example, less than one microsecond and can be controlled as to the length of any stroke and can generate substantial pressures. Operation of the forming apparatus of FIGS. 10 to 13 may be carried out much in the manner of a dot matrix printer with a single line of printer heads.

While the embodiment of FIGS. 10 to 13 show but a single line of pixel elements 32, two, three, four or more rows of pixel elements 32 could be provided on the support beam comprising the platen 16. Since the pixel elements 32 generate substantial forces over their individual heads, first and second platens 16 and 18 may be fixed relative each other for any particular sheet 12. For initial set up for any sheet, mechanisms can be provided to adjust the relative spacing of the upper platen 16, however, to some extent, the stroke of the pixel elements 32 could be controlled to adjust for different thicknesses of the same or different sheets 12.

The preferred embodiments of FIGS. 2 and 3 illustrate the use of piezoelectric actuators for the pixel elements. Other actuators may be used including those which are merely hydraulic and those which are solenoid-like devices. For example, a solenoid mechanism could be used which, when activated with one polarity, moves the pixel element 32 to the extended position and when activated with an opposite polarity, moves the pixel element 32 to the retracted position. Some mechanisms to lock the solenoid in a desired position could be provided.

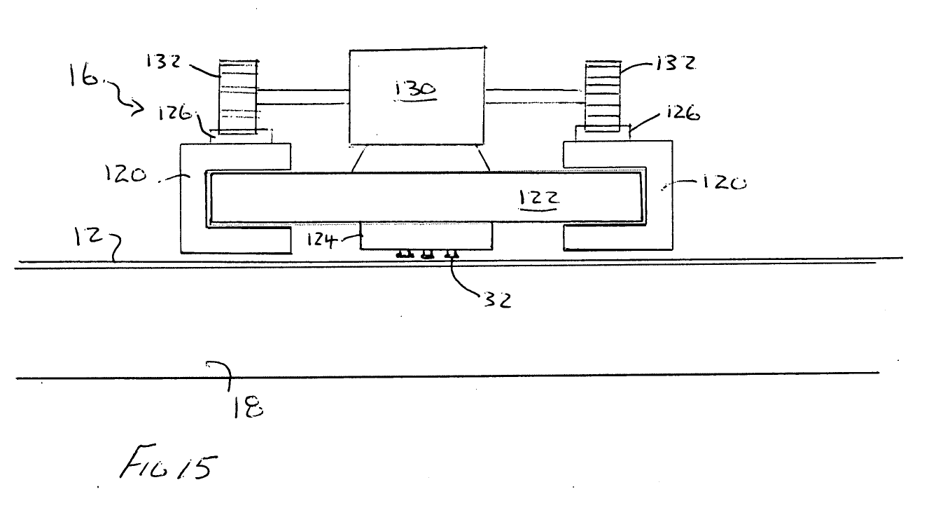

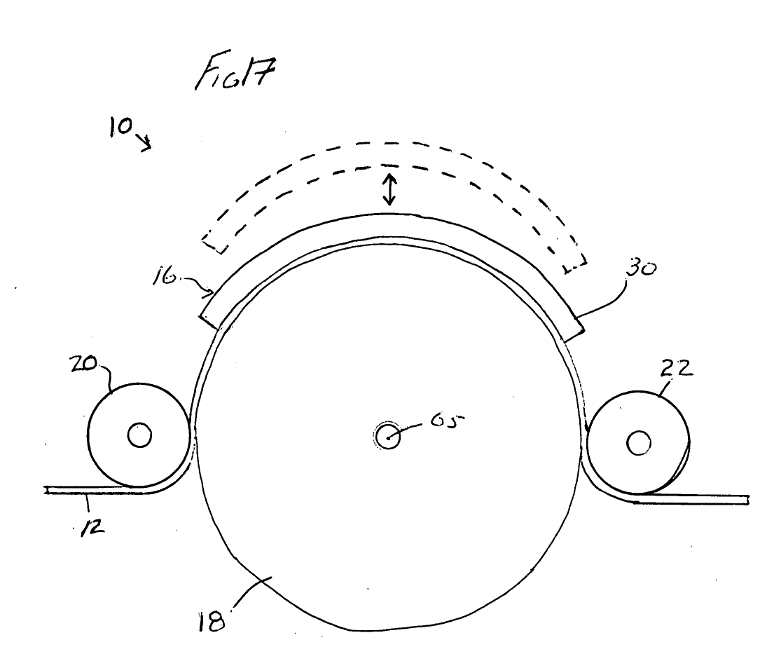

Reference is made to FIGS. 14 to 16 which show an additional embodiment of the invention similar to that in FIGS. 10 to 13 but with the first platen 16 in FIGS. 10 to 13 replaced by an upper platen 16 comprising a pair of parallel U-shaped guide rails 120 within which a carriage member 122 is slidable transverse the width of the sheet 12. The carriage member 122 carries a support block 124 in which a 3 by 3 array of pixel members 32 are mounted.

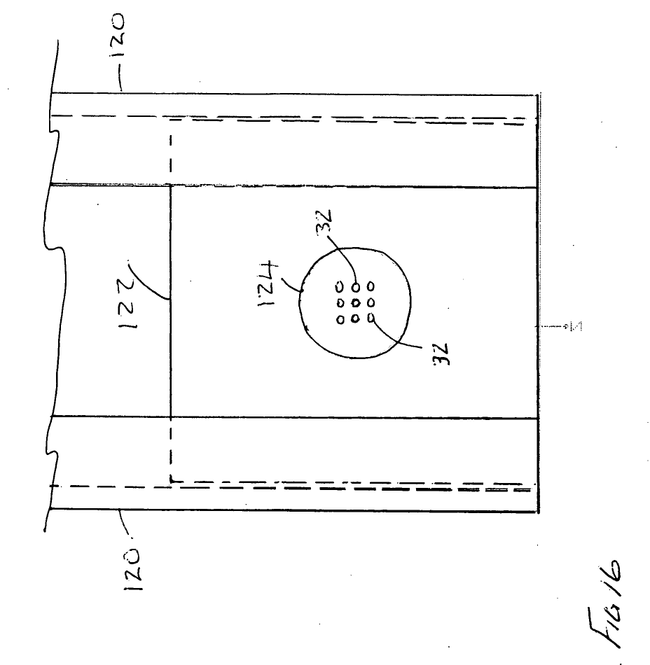

Only FIG. 15 schematically shows a mechanism to slide the carriage member 122 to different locations across the width on the upper platen 16. The movement mechanism includes two racks 126, each secured to an upper surface of the two guide rails 120 and extending along their length. A motor 130 is mounted to the top of the carriage member 122 and drives simultaneously two toothed gears 132 carried on the same axle. The gears 132 engage with the two racks 126. By control of the motor 130, the gears 132 may be rotated relative the racks 126 to quickly and accurately move the carriage member 122 transversely relative the guide rails 120. When the carriage 122 is in any position, any one or more of the pixel elements 32 may be actuated to deform the sheet 12 thereunder. The pixel elements 32 may be controlled to be activated either while the carriage is stationary or while moving.

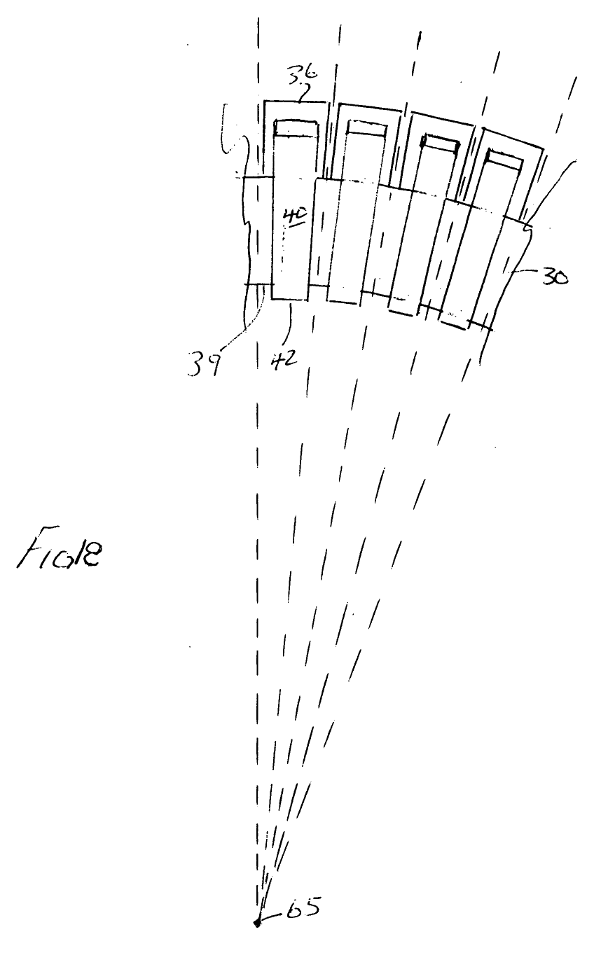

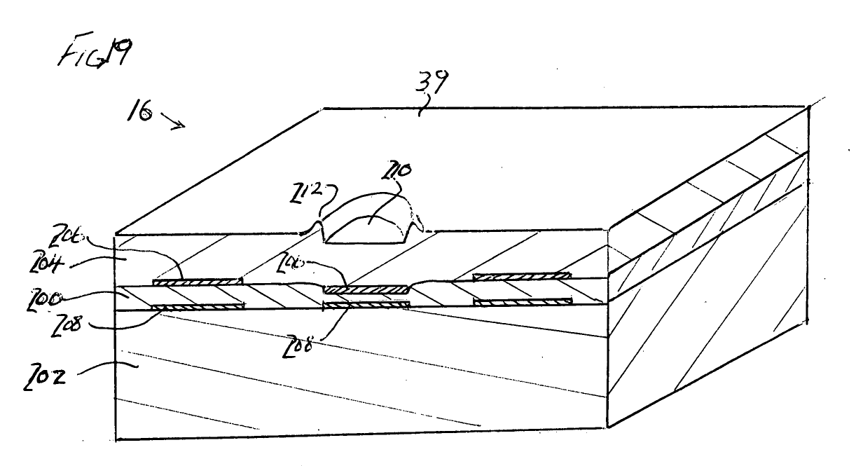

Reference is made to FIGS. 17 and 18 which show a forming apparatus 10 in which the sheet 12 passes over the second platen 18 as guided by two drive rollers 20 and 22. The lower platen 18 and the two guide rollers 20 and 22 are adapted for rotation about parallel axes. A control mechanism (not shown) controls the speed and timing of rotation of the second platen 18 and the drive rollers 20 and 22 so as to advance the sheet 12 in the desired manner, in the case of FIGS. 17 and 18, for intermittent advance, stopping and subsequent advance.

The first platen 16 comprises a portion of a side wall 30 of a cylindrical member. The first platen 16 is adapted for reciprocal movement vertically between an engaged position shown in solid lines and a disengaged position shown in dashed lines.

The first platen 16 carries pixel elements 32 (not shown in FIG. 17) in a manner substantially the same as that in the first embodiment of FIGS. 1, 2 and 3. With each pixel element 32 fixed in a desired position and with the sheet 12 stationary upon the second platen 18, the first platen 16 is urged downwardly into the sheet 12 so as to transfer the input relief from the first platen 16 onto the sheet 12 while the sheet 12 is stationary. Subsequently, the first platen 16 is moved from the engaged position to a disengaged position. In the disengaged position, the relative positioning of the various pixel elements 32 are changed. The sheet 12 is advanced a desired amount approximately equal to the circumferential extent of the input image on the first platen 16. The sheet is then stopped. Subsequently, the first platen 16 is moved from the disengaged position down onto a new area of the sheet 12 to transfer the input relief onto a portion of the sheet 12.

In the context of the concave platen shown in FIGS. 17 and 18, the pixel elements 32 are movable radially inwardly from the recessed position to an extended raised position. As illustrated in FIG. 18, providing the first platen to have its surface 39 concave is advantageous insofar as the heads of the pixel elements 32 will be radially inward and, therefore, the spacing between the heads of the pixel members will be less. As well, the actuation housings 36 being radially outwardly have a greater circumferential extent which they can occupy.

Having the first platen 16 to be concave is, therefore, desired to be of assistance in placing the heads of the pixel elements 32 closer together and, as well, providing increased circumferential room for actuating cylinders 36. FIGS. 17 and 18 illustrate an arrangement with indexed advance of the sheet 12 and reciprocal movement of the first platen 16. The platens are shown as curved, however, flat first platens could also be used.

While operation of the apparatus of FIG. 17 has been described with the first platen 16 movable between the positions shown in solid lines and in dashed lines, this is not necessary if sufficient space is provided between the platens 16 and 18 with the pixel elements 32 retracted for the sheet 12 to be incrementally advanced.

Reference is made to FIG. 19 which illustrates a cross-sectional side view through a platen 16 which is adapted to be the platen which the changeable relief as, for example, the platen 16 in FIGS. 1 to 3. The platen 16 carries a layer of dielectric polymer 200 on a substrate 202. A layer of passive polymer 204 overlies the dielectric polymer 202. A pair of compliant electrodes 206 and 208 are provided on either surface of the dielectric polymer, that is, with one compliant electrode adjacent the substrate and the other compliant electrode at the border between the dielectric polymer and the passive polymer. The compliant electrodes have complementary opposed surface areas. By applying a voltage across the two compliant electrodes, the electrodes attract each other and thereby move closer together, squeezing together and displacing the elastomeric dielectric polymer 202 outwardly from therebetween. This displacement of the elastomeric dielectric polymer 202 causes a resultant complementary deformation of the passive polymer 200 so as to, in effect, provide a relief differential in an outer surface of the passive polymer 200 which typically forms a reduced height portion 210 immediately above the compliant electrodes compared to the other areas of the passive polymer 200 and, as well, typically an enlarged bulge or ridge 212 approximate the outer edge of the compliant electrodes and between the lowered portion of the passive polymer gel coating and its raised portion.

By providing a plurality of pairs of compliant electrodes 206 and 208 over the surface area of the substrate 202 and selectively activating different of the compliant electrodes, variable input relief can be provided on a platen.

The dielectric polymer 202 may comprise an electroactive polymer material as a thin film preferably in the range of about 30 to 60 microns thick. The electroactive polymer material may comprise conductive carbon particles suspended in a soft polymer matrix. By applying plus and minus charges on the opposite side of the dielectric polymer 202, the compliant electrodes 206 and 208 become attracted to each other and the dielectric polymer 202 is squeezed together creating a deformation. The deformations can be used to create embossing patterns.

By controlling the differential between the plus and minus charges on the opposite sides of the dielectric polymer 202, the extent of deformation of the passive polymer 204 can be controlled.

FIG. 19 illustrates three pairs of compliant electrodes 206 and 208, each forming a pixel element 32. The two outside compliant electrodes are not activated and do not show a change in the location of the surface 39 of the platen 16. The middle pair of electrodes have been activated and drawn together so as to provide the recess central area 210 and, as well, peripheral bump 212. By suitable selection of the relative materials, it is possible to merely have the reduced areas and to minimize the extent to which there may be a peripheral bump.

In a further embodiment, a second layer of the passive polymer 204 may be provided between the substrate 202 and the dielectric polymer 200.

The present invention illustrates two specific methods for having pixel elements which can selectively vary the input relief of a platen. In accordance with the present invention, any method of changing the input relief of the first platen may be adapted which permits for suitable real time change of the input relief.

The preferred embodiments show the first platen 16 as carrying pixel elements 32. The pixel elements 32 may be provided in both the first platen 16 and the second platen 18 in each of the embodiments as would be useful for forming relief in both sides of a substrate or sheet. This may have applicability, for example, if the sheet may comprise a thin ductile sheet of metal or a sheet of Bristol board or the like in which creases, lines or stiffening ribs are desired to be formed which have surface details in both surfaces of the sheet. One such product could comprise a thin metal ceiling tile with a three-dimensional relief formed in its surface.

While the invention has been described with reference to preferred embodiments, many modifications and variations will now occur to persons skilled in the art. For a definition of the invention, reference is made to the following claims.

1. An apparatus for forming relief in a surface of a sheet, the apparatus comprising:
a first platen,
a second platen disposed in opposition to the first platen,
the first and second platens adapted to receive a portion of an elongate sheet of material therebetween,
an advance mechanism to advance the sheet relative the platens,
the first platen carrying at least one pixel element reciprocally movable relative the first platen towards the second platen to desired positions between a retracted position and an extended position,
an activation mechanism to move the pixel element between the retracted position and the extended position comprising an electrically induced strain material which generates displacement forces, and
a control mechanism to control the activation mechanism and advance mechanism whereby reciprocal movement of the at least one pixel element form a relief on the surface of the sheet.

2. An apparatus as claimed in claim 1 wherein the activation mechanism comprises a piezoelectric actuator.

3. An apparatus as claimed in claim 2 wherein the piezoelectric actuator incorporates an amplifying mechanism to amplify displacement of a piezoelectric material.

4. An apparatus as claimed in claim 3 wherein the amplifying mechanism is hydraulic.

5. An apparatus as claimed in claim 4 wherein the elongate sheet has a width, at least one pixel element is a row of pixel elements extending across the width of the sheet.

6. An apparatus as claimed in claim 5 wherein the pixel elements are activated to reciprocally move selectively while the advance mechanism advances the sheet.

7. An apparatus as claimed in claim 4 wherein the first platen including a carriage mechanism to move the at least one pixel element relative the second platen transverse to the direction of advance of the sheet.

8. An apparatus as claimed in claim 4 wherein the first platen comprises a roller journalled about an axis and having an outer surface carrying the at least one pixel element, the roller continuously rotating to successively bring each pixel element into engagement with the sheet.

9. A method of forming relief in a surface of a substrate comprising selectively reciprocally moving with a piezoelectric actuator, a relief forming head of a pixel element into and away from the surface of the sheet at different locations over an area of the sheet.

10. An apparatus for forming relief in a surface of a sheet, the apparatus comprising:
a first platen,
a second platen disposed in opposition to the first platen,
an input relief carried on the first platen,
the first and second platens adapted to receive a portion of an elongate sheet of thermoplastic material therebetween sandwiching the sheet between the platens such that contact of a surface of the sheet with the first platen forms an output relief in said surface of the sheet corresponding to the input relief,
an advance mechanism to advance the sheet relative the platens for successive forming of the output relief on the surface at different portions of the sheet,
the first platen comprising a plurality of pixel elements arranged adjacent each other in an array with each pixel element defining a segment of the input relief of the first platen,
each pixel element movable relative the first platen between a retracted position and an extended position,
an activation mechanism to move each pixel element between the retracted position and the extended position, and
a control mechanism to control the activation mechanism and advance mechanism whereby the input relief can be varied by the movement of the pixel elements to change the input relief with time and thus form different output reliefs on different portions of the surface of the sheet.

11. An apparatus as claimed in claim 10 wherein the elongate sheet has a width, the array of pixel elements extending across the width of the sheet.

12. An apparatus as claimed in claim 11 wherein forming of the output relief on the surface at different portions of the sheet comprises forming simultaneously across the width of the sheet over each different portion.

13. An apparatus as claimed in claim 12 wherein the elongate sheet is advanced between the platens parallel a longitudinal of the sheet and the output relief is sequentially formed on the surface at different portions of the sheet as the portions are sequentially advanced between the platens.

14. An apparatus as claimed in claim 13 wherein at least one of the platens comprises a roller extending across the width of the sheet and rotatable about an axis normal to the longitudinal of the sheet,
the roller rotatable about its axis with advance of the sheet between the platens.

15. An apparatus as claimed in claim 13 wherein the first platen comprises a roller extending across the width of the sheet and rotatable about an axis normal to the longitudinal of the sheet,
the roller rotatable about its axis with advance of the sheet between the platens,
the roller carrying the pixel elements for movement radially inwardly in movement to the retracted position and movement radially outwardly in movement to the extended position such that an outwardly directed surface of the roller carries the input relief,
the pixel elements arranged in the array on the roller in at least one row of pixel elements extending axially across the roller and across the width of the sheet,
with rotation of the roller each row of the pixel elements being rotated between an engaged sector in which the pixel elements of the row are engaged with the sheet and disengaged sector in which the pixel elements of the row are not engaged with the sheet,
the control mechanism changing the input relief by selectively moving pixel elements in each row when that row is in the disengaged sector.

16. An apparatus as claimed in claim 15 wherein the control mechanism changing the input relief by selectively moving pixel elements in each row when that row is in the disengaged sector.

17. An apparatus as claimed in claim 15 wherein
the pixel elements are arranged in the array on the roller in a plurality of rows of pixel elements,
each row extending axially across the roller across the width of the sheet,
the plurality of rows extending continuously about the entire circumference of the roller whereby the roller may continuously rotate with the sheet advancing at the same speed as the input relief for continuous forming of the output relief in the surface of the sheet with rotation of the roller.

18. An apparatus as claimed in claim 10 wherein:
each pixel member includes an elongate stem with a head at one end,
the head comprising the segment of the input relief of the first platen for that pixel member,
a chamber carried by the first platen for each pixel element,
the chamber having an outwardly directed open end,
the stem of each pixel element slidably received in its respective chamber for sliding relative the chamber between its retracted position and its extended position,
in the extended position the head of each pixel element extending from the open end of its respective chamber.

19. An apparatus as claimed in claim 18 wherein:
each chamber is defined within a housing for each pixel element,
each housing secured to the first platen.

20. An apparatus as claimed in claim 19 wherein the activation mechanism to move each pixel element between the retracted position and the extended position is coupled between the respective housing and the stem of each pixel element.

21. An apparatus as claimed in claim 20 wherein the activation mechanism to move each pixel element between the retracted position and the extended position is carried by the respective housing of each pixel element.

22. An apparatus as claimed in claim 18 wherein the activation mechanism to move each pixel element between the retracted position and the extended position is a piezoelectric actuator.

23. An apparatus as claimed in claim 13 wherein the platens are movable relative each other towards and away from each other between an embossing position in which sheet is sandwiched between the platens with the pixel elements engaging with the sheet and a withdrawn position in which the pixel elements are not engaged with the sheet,
the control mechanism changing the input relief by selectively moving pixel elements when the platen is in the withdrawn position.

24. An apparatus as claimed in claim 13 wherein the sheet comprises a thermoplastic material including heating means to heat the sheet to a temperature at which the sheet is permanently deformed by the first platen forming the output relief in said surface of the sheet, and cooling means to cool the sheet after the output relief has been formed in the said surface of the sheet.

25. A method of forming relief in a surface of a thermoplastic sheet comprising the steps of:
step (1): sandwiching a first portion of an elongate sheet of thermoplastic material between a first portion of first platen and a second platen disposed in opposition to the first platen such that contact of a surface of the first portion of the sheet with the first portion of the first platen forms a first output relief in said surface of the first portion of the sheet corresponding to a relief on the first portion of the first platen, and
step (2): removing the first portion of the first platen from contact with the sheet,
step (3): changing the relief on the first portion of the first platen to become different than the relief in an immediately preceding sandwiching step,
step (4): sandwiching between the first portion of first platen and the second platen disposed in opposition to the first platen a different portion of the elongate sheet of thermoplastic material that has not been sandwiched in a previous sandwiching step such that contact of a surface of the different portion of the sheet with the first portion of the first platen forms an output relief in said surface of the different portion of the sheet corresponding to the relief on the first portion of the first platen.

26. A method as claimed in claim 25 wherein, after step (4),
subsequently repeating steps (2) to (4).

27. A method of forming relief in a surface of a sheet comprising the steps of:
a sandwiching step (1) of sandwiching a first portion of an elongate sheet of thermoplastic material between a first portion of first platen and a second platen disposed in opposition to the first platen such that contact of a surface of the first portion of the sheet with the first portion of the first platen forms a first output relief in said surface of the first portion of the sheet corresponding to an input relief on the first portion of the first platen, and
a removing step (2) of removing the first portion of the first platen from contact with the sheet,
a sandwiching step (3) of sandwiching between the first portion of first platen and the second platen disposed in opposition to the first platen a different portion of the elongate sheet of thermoplastic material than has been sandwiched in a previous sandwiching step such that contact of a surface of the different portion of the sheet with the first portion of the first platen forms an output relief in said surface of the different portion of the sheet corresponding to the relief on the first portion of the first platen, and
subsequently repeating removing step (2) and sandwiching step (3),
wherein after carrying out at least one said removing step (2) and before carrying out a sandwiching step (3) immediately following said removing step (2), carrying out a changing step of changing the input relief on the first portion of the first platen to become different than the input relief in the sandwiching step (3) immediately preceding said removing step (2).

28. A method as claimed in claim 27 wherein:
the first platen comprising a plurality of pixel elements arranged adjacent each other in an arrangement selected from a row and an array with each pixel element movable relative the first platen between a retracted position and an extended position,
each pixel element defining a segment of the input relief of the first platen which input relief varies dependant on the position of each pixel element between its retracted position and its extended position,
the changing step of changing the input relief on the first portion of the first platen comprising moving selected of the pixel elements to a desired position between its retracted position and its extended position.

29. A method as claimed in claim 27 including
providing each portion of the elongate sheet of thermoplastic material to be sandwiched in any sandwiching step (3) at a temperature at which the sheet will be permanently deformed by the first platen forming the output relief in said surface of the sheet, and cooling each portion of the sheet after the output relief has been formed in the said surface of that portion of the sheet to a temperature at which the sheet will be substantially permanently retain the output relief.

30. A method as claimed in claim 29 wherein the sheet is advanced relative the platens parallel a longitudinal of the sheet and the sheet has a width normal to the longitudinal,
said row or array extending entirely across the width of the sheet.
